(19) United States
(12) Patent Application Publication
(10) Pub. No.: US 2026/0315973 A1
(43) Pub. Date: Oct. 15, 2026

(54) STACKED FILTER ARRANGEMENT

(71) Applicant: Donaldson Company, Inc., Bloomington, MN (US)

(72) Inventors: Abbas SALHAB, Poole (GB); Aaron S. PEACH, Weymouth (GB)

(73) Assignee: Donaldson Company, Inc., Bloomington, MN (US)

(21) Appl. No.: 19/485,575

(22) PCT Filed: May 16, 2024
(86) PCT No.: PCT/US2024/029705

§ 371 Date: Nov. 18, 2025

Related U.S. Application Data
(60) Provisional application No. 63/467,475, filed on May 18, 2023.

(51) Int. Cl. B01D 46/00; B01D 46/02; B01D 46/12; B01D 46/62; B01D 46/88

(52) U.S. Cl. CPC B01D 46/0005; B01D 46/023; B01D 46/12; B01D 46/62; B01D 46/88; B01D 2265/025

(57) ABSTRACT

A filter arrangement includes a first filter assembly; a second filter assembly; and a cam assembly to cause an airtight seal between the first filter assembly and second filter assembly. The cam assembly pushes the first filter assembly into sealing engagement with a first sump frame, which pushes the floating shelf toward the second filter assembly and a second sump frame into sealing engagement with the second filter assembly. The filter arrangement can be used in a system including a 3D printer producing a fluid stream of fumes and particles, in which the filter arrangement is oriented to filter the fluid stream. The filter arrangement may alternatively have a floating shelf secured to the housing; a sump frame extending from the floating shelf, and the floating shelf being adjustable to selectively seal the second filter assembly to the sump frame.

### CROSS REFERENCE TO RELATED APPLICATION

This application is being filed on May 16, 2024, and claims priority to U.S. provisional patent application 63/467,475, filed May 18, 2023, incorporated herein by reference in its entirety.

### TECHNICAL FIELD

This disclosure relates to filters for cleaning fluid, such as airstreams having fumes and particles. In particular, this disclosure relates to a stacked filter arrangement for use with a 3D printer, or other equipment such as CO₂ Laser Engraving, Fiber Laser Marking, or UV Laser Marking.

### BACKGROUND

Some 3D printers, or other types of engraving or marking equipment, are used in a hazardous environment, such as when used with PVC applications, and hydrochloric acid is created. Filter systems used with this types of equipment extract all of the generated fumes and particles, including caustic waste, which pass through the internal filter components. If the filter is not changed timely, a saturated filter that is airtight with the filter housing, can cause permanent damage to the filter housing via melting or rust. This can lead to a housing failure, create contamination risk. In addition, in the prior art systems, when the user opens the door to the filter system, there can be exposure to fumes.

Improvements are desirable.

### SUMMARY

In one aspect, a filter arrangement is provided comprising: a first filter assembly; a second filter assembly; and a cam assembly to cause an airtight seal between the first filter assembly and second filter assembly.

The filter arrangement can include a housing with a surrounding wall defining an interior volume; an unfiltered fluid inlet through the surrounding wall; a filtered fluid outlet through the surrounding wall; and wherein the first filter assembly, second filter assembly, and cam assembly are operably oriented within the interior volume of the housing.

In example embodiments, the first filter assembly is positioned to rest on the cam arrangement and receive unfiltered fluid from the unfiltered fluid inlet.

Example embodiments include a fixed shelf within the interior volume of the housing and secured to the housing; and floating shelf movably mounted to the fixed shelf; the floating shelf including an upper face, an opposite lower face, a first sump frame, and a second sump frame; the first sump frame extending from the lower face in a direction away from the floating shelf and sized and positioned to form a releasable seal with the first filter assembly; and the second sump frame extending from the upper face in a direction away from the floating shelf and sized and positioned to form a releasable seal with the second filter assembly.

In one or more embodiments, the second filter assembly is positioned on the fixed shelf and to provide filtered fluid to the filtered fluid outlet, and can be positioned on the first sump frame on the floating shelf, when the floating shelf is moved into such a position.

In some examples, the cam assembly includes a pivotable handle controlling a cam lobe, wherein the cam lobe is positioned to push the first filter assembly into sealing engagement with the first sump frame and push the floating shelf toward the second filter assembly and the second sump frame into sealing engagement with the second filter assembly.

In some examples, a pump shelf secured within the housing interior volume; the pump shelf having an upper surface, an opposite lower surface; and an opening; a pump positioned on the upper surface of the pump shelf over the opening; and a third sump frame extending from the lower surface of the pump shelf and away from the pump shelf; the third sump frame being sized and positioned to form a releasable seal with the second filter assembly.

The first filter assembly includes, in examples, an airtight outer box; a cage box positioned inside of the outer box; and a removable and replaceable pocket bag filter member positioned in the cage box.

In some embodiments, the second filter assembly includes a filter housing holding a removable and replaceable HEPA filter media section and carbon media section.

In another aspect, a system is provided including a 3D printer producing a fluid stream of fumes and particles, and the filter arrangement, as characterized above, oriented to filter the fluid stream.

In another aspect, a method of filtering is provided including: (a) engaging a cam assembly to move a first filter assembly into sealing engagement with a first sump frame attached to a floating shelf; (b) moving the floating shelf to result in sealing engagement between a second sump frame and a second filter assembly; and (c) moving the second filter assembly into sealing engagement with a third sump frame.

In some example methods, the first filter assembly includes: an airtight outer box; a cage box positioned inside of the outer box; and a removable and replaceable pocket bag filter member positioned in the cage box; and the second filter assembly includes a filter housing holding a removable and replaceable HEPA filter media section and carbon media section.

In another aspect, a filter arrangement is provided comprising: a housing with a surrounding wall defining an interior volume; an unfiltered fluid inlet through the surrounding wall; and a filtered fluid outlet through the surrounding wall; a first filter assembly in communication with the unfiltered fluid inlet; a second filter assembly releasably sealed to the first filter assembly; a floating shelf secured to the housing; the floating shelf including an upper face, an opposite lower face, and a sump frame extending from the lower face; wherein the floating shelf is adjustable to selectively seal the second filter assembly to the sump frame.

In example embodiments, the filter arrangement further comprises a fixed shelf within the interior volume of the housing and secured to the housing; and wherein the floating shelf is movably mounted to the fixed shelf.

Some embodiments further comprise: a spring mounted on the fixed shelf and providing a spring force between the fixed shelf and the floating shelf; and a solenoid mounted on the fixed shelf to provide a force against the floating shelf, when actuated.

Example embodiments can further include: a pump shelf secured within the housing interior volume; the pump shelf having an upper surface, an opposite lower surface; and an opening; a pump positioned on the upper surface of the pump shelf over the opening; and a spigot extending from the opening and from the lower surface of the pump shelf and away from the pump shelf, the floating shelf being slidingly sealed to the spigot.

In some arrangements, the filtered fluid outlet is downstream of the pump shelf and pump.

For some example embodiments, the first filter assembly includes: an airtight outer box; a cage box positioned inside of the outer box; and a removable and replaceable pocket bag filter member positioned in the cage box.

In some arrangements, the second filter assembly includes a filter housing holding a removable and replaceable HEPA filter media section and carbon media section.

In another aspect, a system is provided including a 3D printer producing a fluid stream of fumes and particles, and the filter arrangement as characterized above, oriented to filter the fluid stream.

In another aspect, a method of filtering is provided comprising: providing a housing with a surrounding wall defining an interior volume; an unfiltered fluid inlet through the surrounding wall; and a filtered fluid outlet through the surrounding wall; putting a stacked filter assembly in communication with the unfiltered fluid inlet; and disengaging a solenoid to move the stacked filter assembly into sealing engagement with the filtered fluid outlet.

Some example methods include the step of disengaging a solenoid as including moving
a sump frame attached to a floating shelf to seal the stacked filter assembly to the sump frame.

Example methods include having: a pump shelf is secured within the housing interior volume; the pump shelf having an upper surface, an opposite lower surface; and an opening; a pump positioned on the upper surface of the pump shelf over the opening; and a spigot extending from the opening and from the lower surface of the pump shelf and away from the pump shelf, the floating shelf being slidingly sealed to the spigot.

In examples, the stacked filter assembly includes: a first filter assembly in communication with the unfiltered fluid inlet; and a second filter assembly releasably sealed to the first filter assembly.

In another aspect, a filter arrangement is provided comprising: a housing with a surrounding wall defining an interior volume; an unfiltered fluid inlet through the surrounding wall; and a filtered fluid outlet through the surrounding wall; a first filter assembly in communication with the unfiltered fluid inlet; a second filter assembly; a floating shelf secured to the housing; and a sealing arrangement to provide an air tight seal between the first filter assembly, second filter assembly, and the filtered fluid outlet.

In some examples, the sealing arrangement includes a cam assembly to cause an airtight seal between the first filter assembly and second filter assembly.

In some examples, the sealing arrangement includes: the floating shelf having an upper face, an opposite lower face, and a sump frame extending from the lower face; and the floating shelf being adjustable to selectively seal the second filter assembly to the sump frame.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

It is noted that there is no specific requirement that a feature, component, assembly or method include all of the detail characterized herein, in order to obtain some benefit according to the present disclosure.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a rear perspective view of an embodiment of a filter arrangement, constructed in accordance with principles of this disclosure;

FIG. 2 is a front perspective view of the filter arrangement of FIG. 1;

FIG. 3 is a perspective view similar to FIG. 2, but having the housing walls transparent to show internal components;

FIG. 4 is a front view of FIG. 3;

FIG. 5 is an enlarged perspective view of a portion of the filter arrangement of FIG. 1;

FIG. 6 is an enlarged perspective view of a portion of FIG. 5;

FIG. 7 is a perspective view of a fixed shelf and floating shelf assembly used in the filter arrangement of FIG. 1;

FIG. 8 is a perspective view of a pump shelf used in the filter arrangement of FIG. 1;

FIG. 9 is a perspective view a cam assembly used in the filter arrangement of FIG. 1;

FIG. 10 is a perspective view of the cam assembly of FIG. 9;

FIG. 11 is a front view of a portion of the filter arrangement of FIG. 1, holding a first filter assembly;

FIG. 12 is a perspective view the first filter assembly;

FIG. 13 is an exploded perspective view of the first filter assembly of FIG. 12;

FIG. 14 is a front view of a portion of the filter arrangement of FIG. 1, holding a second filter assembly;

FIG. 15 is a perspective view of the second filter assembly of FIG. 14;

FIG. 16 is a perspective view of a pump secured to a pump plate and the pump shelf of FIG. 8;

FIG. 17 is a perspective view of the pump shelf of FIG. 8;

FIG. 18 is a top plan view of a bag filter used in the first filter assembly of FIG. 12;

FIG. 19 is a rear elevation view of the bag filter of FIG. 18;

FIG. 20 is a right elevation view of the bag filter of FIG. 18;

FIG. 21 is an perspective view of the second filter assembly of FIG. 15;

FIG. 22 is a schematic front view of another embodiment of a filter arrangement, constructed in accordance with principles of this disclosure, showing interior components including a floating shelf in a first position;

FIG. 23 is a schematic side view of the filter arrangement of FIG. 22; and

FIG. 24 is a schematic front view of the filter arrangement of FIG. 22 and showing the floating shelf in a second position.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A filter arrangement constructed according to principles of this disclosure is shown in general at 100. The filter arrangement 100 is arranged so that filter assemblies are arranged stacked on top of each other, to create a closed system and limit contamination when the one or more of the filter assemblies are saturated and need replacement. In addition, when the user opens the door to the filter arrangement, there is no exposure to any fumes as all the filters are acting as a single system. This results in containing all the fumes within the filters and limit the exposure to the outside environment.

The filter arrangement 100 includes a first filter assembly 102. The first filter assembly 102, when arranged in the filter arrangement 100, will be the first filter that is encountered by an incoming fluid stream of fumes/contaminants. As such the first filter assembly 102 is a pre-filter 103.

The filter arrangement 100 also includes a second filter assembly 104. The second filter assembly 104 is typically arranged downstream of the first filter assembly 102 and axially stacked on or above the first filter assembly 102.

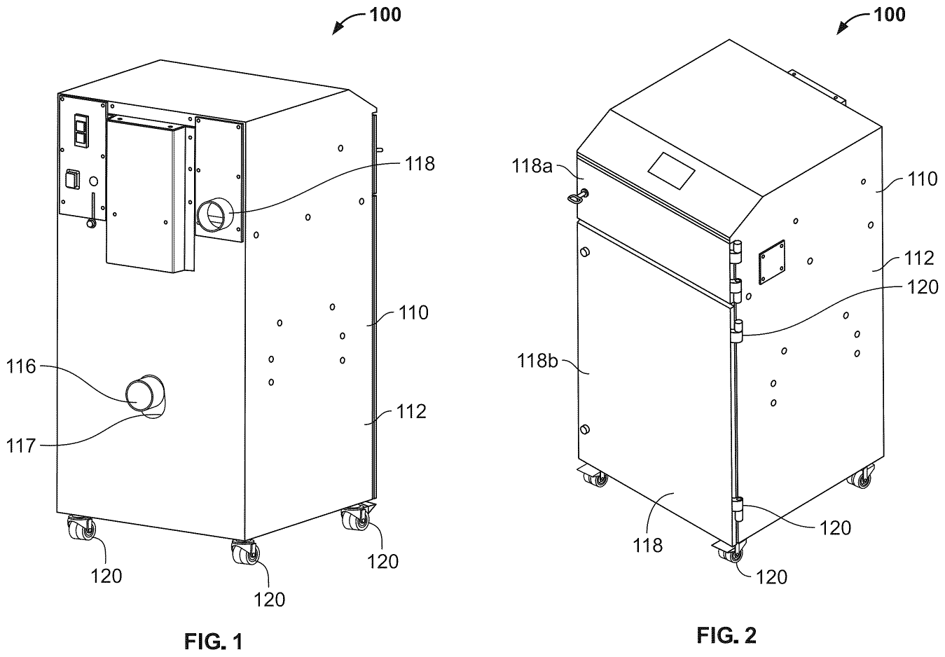

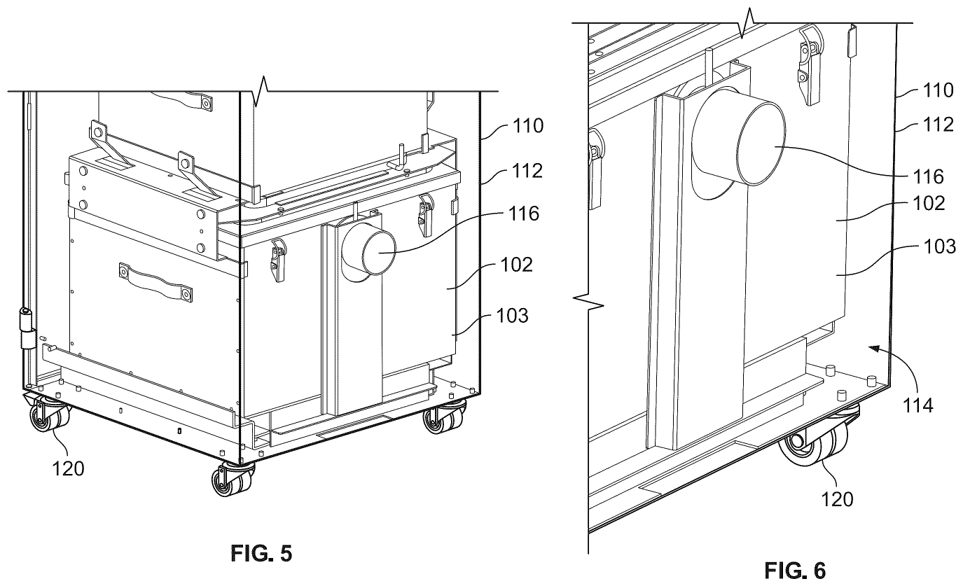

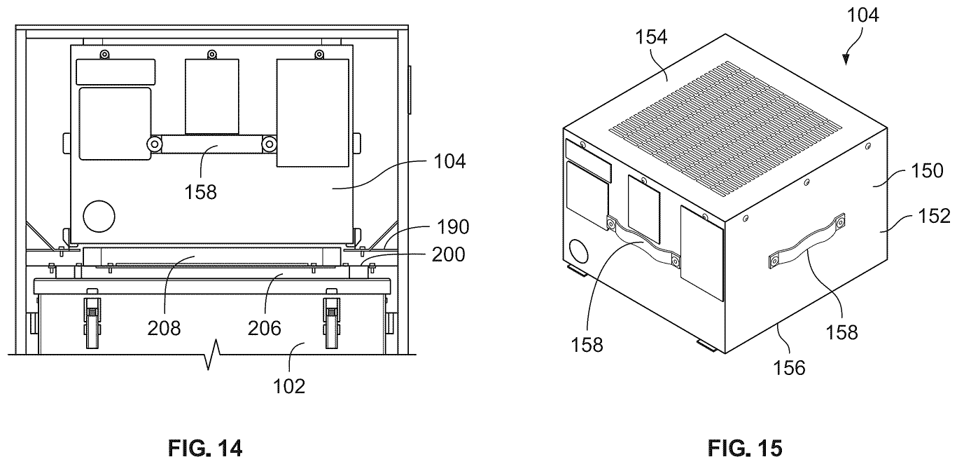

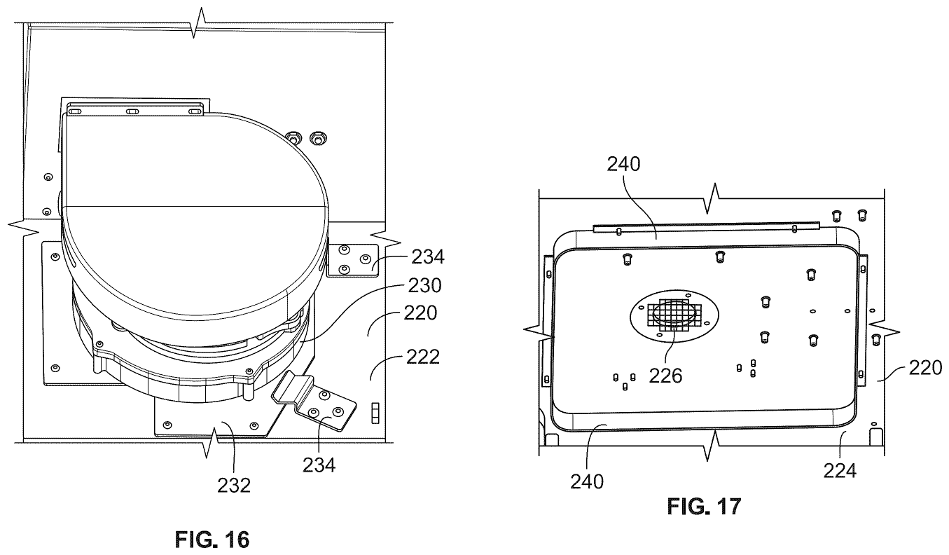

### The Embodiment of FIGS. 1-21

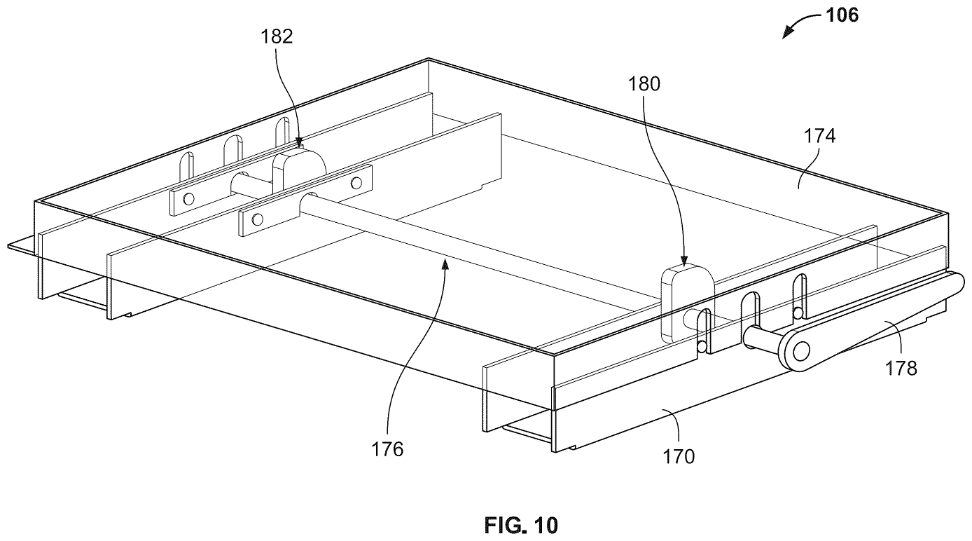

The filter arrangement 100 further includes a cam assembly 106 (FIGS. 9 and 10) to cause a releasable airtight seal between the first filter assembly 102 and second filter assembly 104.

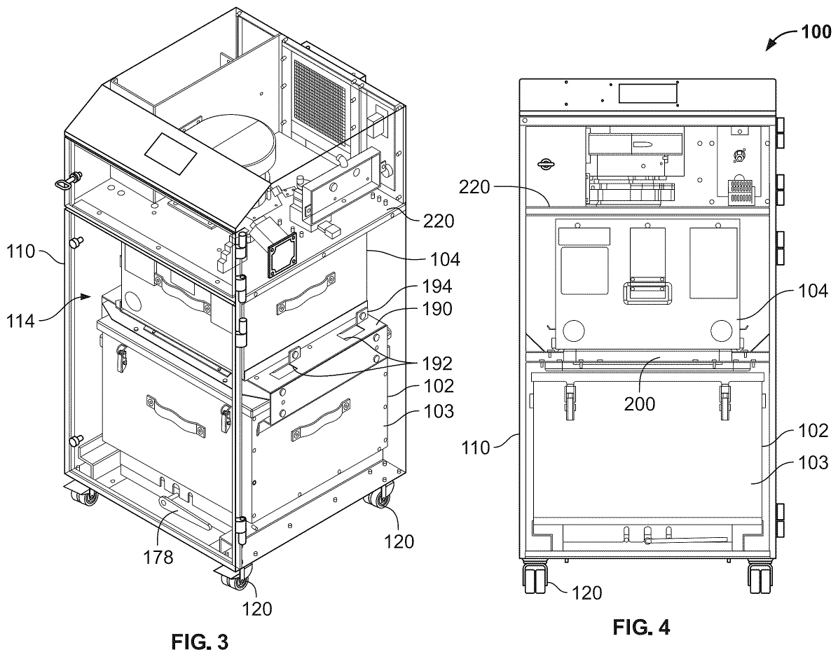

The filter arrangement 100 includes a housing 110 with a surrounding wall 112 defining an interior volume 114 (FIG. 3). The housing 100 has an unfiltered fluid inlet 116 through the surrounding wall 112, and a filtered fluid outlet 118 through the surrounding wall 112. As can be seen in FIG. 1, an opening 117 in the housing wall 112 for the fluid inlet 116 is oblong to allow the inlet 116 to move up and down relative to the housing 110. The inlet 116 can be connected to a hose or other conduit downstream of equipment, such as a 3D printer.

The front wall 118 of the housing 100 can be attached to a remaining portion of the housing 110 with hinges 120, so that the interior volume 114 is accessible by pivoting the front wall 118 away from a remaining portion of the housing 100. The front wall 118 can have an upper portion 118a and a lower portion 118b, each of which can allow access to the interior volume 114 of the housing 110.

The filter arrangement 100 can be portable. As shown here, the filter housing is supported by wheels or casters 120 to allow for portability.

The first filter assembly 102, second filter assembly 104, and cam assembly 106 are operably oriented within the interior volume 114 of the housing 110. The first filter assembly 102 is positioned to rest on the cam assembly 106 and receive unfiltered fluid from the unfiltered fluid inlet 116.

One example embodiment of the first filter assembly 102 is shown in FIGS. 12, 13, and 18-20. The first filter assembly 102 includes an airtight outer box 130. A cage box 132 is positioned inside of the outer box 130. A perforated outer cage box lid 134 is removably positioned to cover the outer box 130 and cage box 132. The outer box 130 further includes straps 136 along the outside for handling the first filter assembly 102. In FIG. 13, an inlet opening 137 is shown passing through the outer box 130. The inlet opening 137 is in communication with the inlet 116.

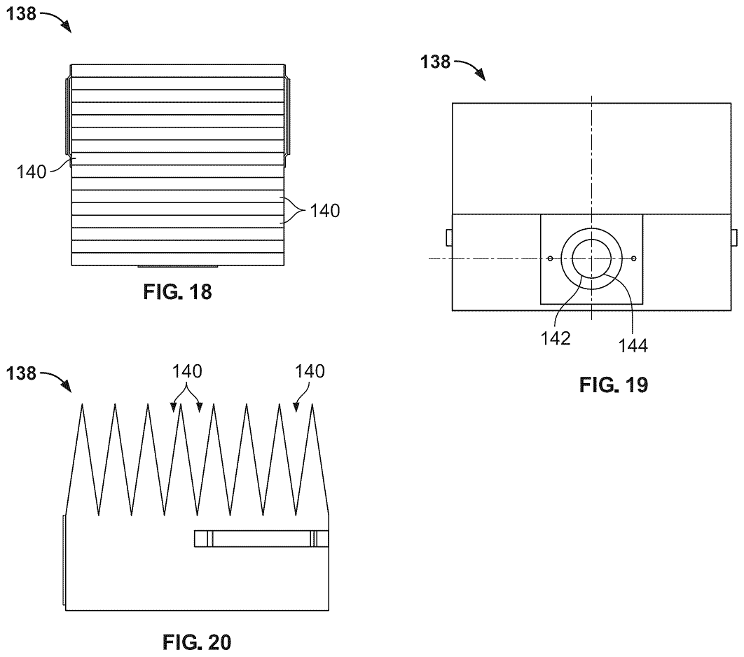

A removable and replaceable pocket bag filter member 138 (FIGS. 18-20) is positioned in the cage box 132. While there can be alternatives, in the example shown, the pocket bag filter member 138 can be constructed from polyester, polypropylene, acrylic fiber filter media. It can have a plurality of pockets 140, and in the example shown, 8 pockets 140. In FIG. 19, the rear elevation view is shown. An inlet opening 142 is circumscribed by a rubber gasket seal 144, which forms a releasable seal against an inside wall of the outer box 130 around the inlet opening 137.

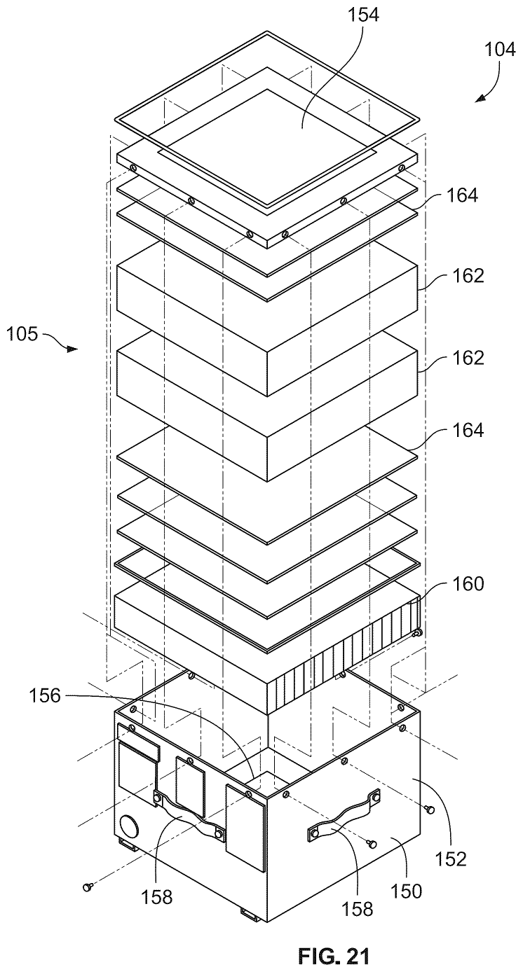

An example embodiment of the second filter assembly 104 is shown in FIGS. 15 and 21. The second filter assembly 104 includes a filter housing 150. The filter housing 150 can be an airtight outer box 152 having a removable perforated cover 154. The outer box 152 further includes straps 158 along the outside for handling the second filter assembly 104. The bottom panel 156 of the box 152 is perforated to allow for the flow of air/fluid into the second filter assembly 104. The perforated cover 154 allows filtered air to exit the second filter assembly 104.

The second filter assembly 104 holds filter media 105. Many types and arrangements can be used. In this example, there are at least two distinct types of filter media 105. The first section of media is a HEPA filter media section 160, and the second section of media is a carbon media section 162. In FIG. 21, there are two sections of carbon media 162, axially stacked on each other, and stacked on the HEPA media section 160. Filter pads 164 are included both upstream and downstream (axially under and over) the carbon media sections 162. The filter media 105 can be removable and replaceable within the outer box 152 of the second filter assembly 104.

In FIG. 10, an example embodiment of the cam assembly 106 is shown. The cam assembly 106 has a pair of parallel bases 170, 172, supporting a platform 174. The platform 174 is sized to hold and support the first filter assembly 102. A cam shaft rod 176 extends across the assembly 106 and through lateral sides of the platform 174 and bases 170, 172. The rod 176 is rotatable relative to the platform 174 and bases 170, 172. A pivotable handle 178 is outside of the platform 174 and bases 170, 172 and is secured to the rod 176. The handle 178 can be pivoted within a plane perpendicular to the rod 176. A pair of cam lobes 180, 182 are secured to the rod 176 so that when the handle 178 is pivoted, the rod 176 is rotated, and the lobes 180, 182 are rotated. The lobes 180, 182 will then push up on the platform 174, which pushes the first filter assembly 102 upward.

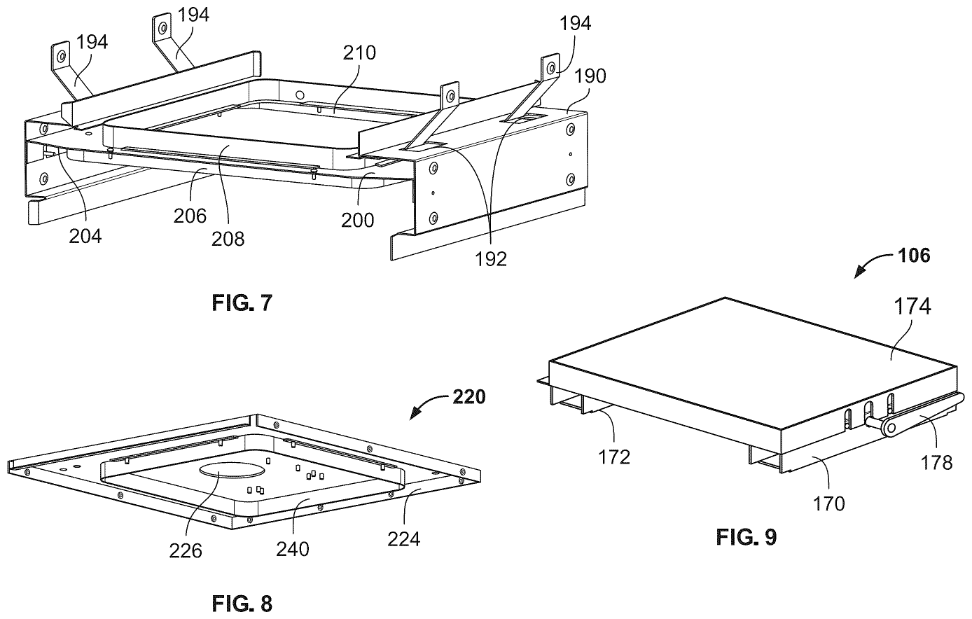

The filter arrangement 100 further includes a fixed shelf 190 (FIG. 7) within the interior volume 114 of the housing 110 and secured to the housing 110. The fixed shelf 190 holds and supports the second filter assembly 104 so that the second filter assembly 104 is positioned to provide filtered fluid/air to the filtered fluid outlet 118. The fixed shelf 190 is permanently mounted/fixed to the housing 110 above the first filter assembly 102. The fixed shelf 190 includes openings 192, which accommodate struts 194 from a floating shelf 200, described below. The struts 194 help support the second filter assembly 104.

The floating shelf 200 is movably mounted to the fixed shelf 190. The floating shelf 200 includes an upper face 202, an opposite lower face 204, a first sump frame 206, and a second sump frame 208. The floating shelf 200 has a central opening 210. The first sump frame 206 extends from the lower face 204 in a direction away from the floating shelf 200 and surrounding the central opening 220. The first sump frame 206 is sized and positioned to form a releasable seal with the first filter assembly 102. The second sump frame 208 extends from the upper face 202 in a direction away from the floating shelf 200 and surrounds the central opening 220. The second sump frame 208 is sized and positioned to form a releasable seal with the second filter assembly 104.

When the cam lobes 108, 182 push the first filter assembly 102 upward, the first filter assembly 102 is pushed into sealing engagement with the first sump frame 206, which pushes the floating shelf 200 toward the second filter assembly 104. This then pushes the second sump frame 208 into sealing engagement with the second filter assembly 104. The first filter assembly 102 and the second filter assembly 104 are then in air tight communication with each other. The second filter assembly 104 is positioned on the first sump frame 206 on the floating shelf 200, in this condition.

The filter arrangement 100 further includes a pump shelf 220 (FIGS. 8, 16, and 17). The pump shelf 220 is secured within the housing interior volume 114 above the second filter assembly 104. The pump shelf 220 has an upper surface 222, an opposite lower surface 224, and an opening 226 therethrough.

A pump 230 is positioned on the upper surface 222 of the pump shelf 220 over the opening 226. The pump 230 will draw fluid flow from the inlet 116, through the first filter assembly 102, then through the second filter assembly 104, and exhaust the filtered air through the outlet 118. A pump plate 232 is screwed to the pump shelf 220. Tension brackets 234 are used to help hold the pump 230 in position.

A third sump frame 240 extends from the lower surface 224 of the pump shelf 220 and away from the pump shelf 220. The third sump frame 240 is sized and positioned to form a releasable seal with the second filter assembly 104. When the cam lobes 108, 182 push the first filter assembly 102 upward, the first filter assembly 102 is pushed into sealing engagement with the first sump frame 206, which pushes the floating shelf 200 toward the second filter assembly 104. This then pushes the second sump frame 208 into sealing engagement with the second filter assembly 104. The second filter assembly 104 is pushed into sealing engagement with the third sump frame 240.

The above assembly can be used in a method of filtering. The method can include engaging the cam assembly 106 to move the first filter assembly 102 into sealing engagement with the first sump frame 206 attached to floating shelf 200. This will also include moving the floating shelf 200 to result in sealing engagement between the second sump frame 208 and the second filter assembly 104. The method can also include moving the second filter assembly 104 into sealing engagement with the third sump frame 240.

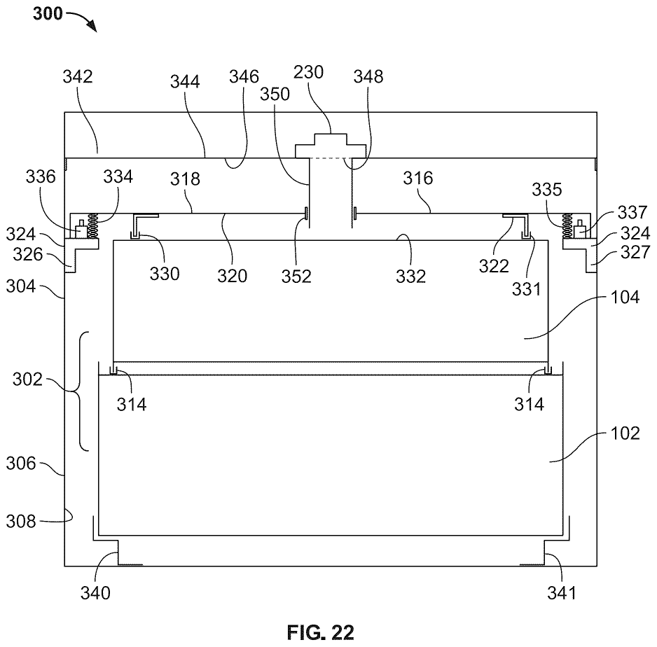

### The Embodiment of FIGS. 22-24

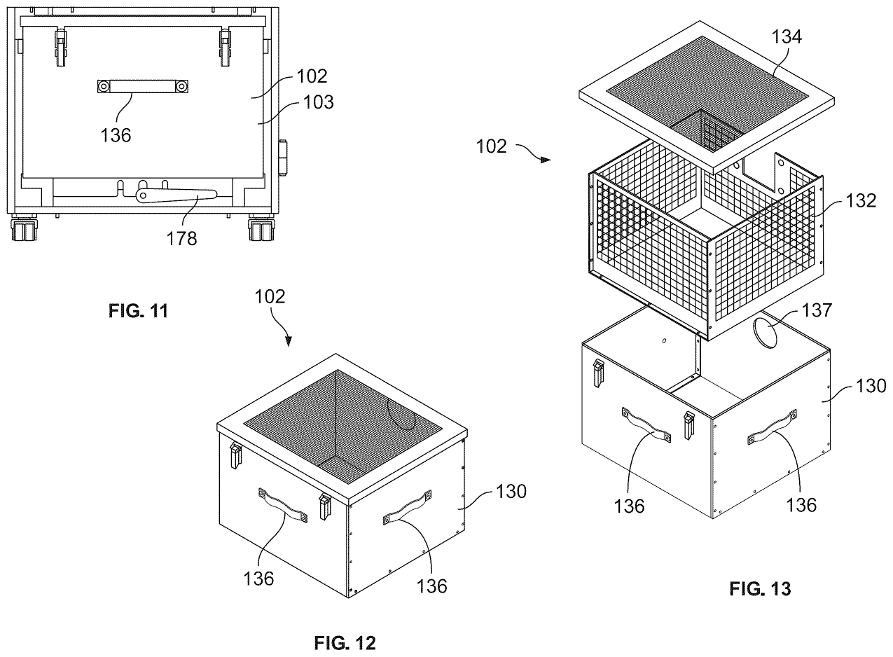

Turning now to FIGS. 22-24, another embodiment of a filter arrangement is shown at 300. The filter arrangement 300 includes some common features as the filter arrangement 100, including a stacked filter assembly 302. The stacked filter assembly 302 includes first filter assembly 102 and second filter assembly 104; each of the filter assemblies 102, 104 being as described above, especially as shown and described in FIGS. 11-15, 18 and 20.

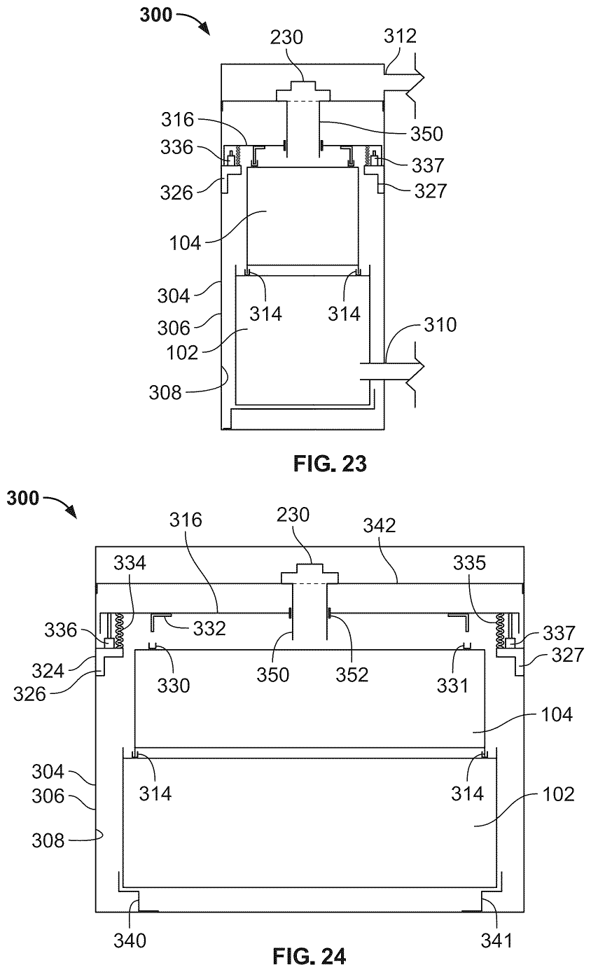

The filter arrangement 300 includes a housing 304 with a surrounding wall 306 defining an interior volume 308. In FIG. 23, an unfiltered fluid inlet 310 extends into and through the surrounding wall 306. A filtered fluid outlet 312 also extends through the surrounding wall, downstream of the stacked filter assembly 302.

The first filter assembly 102 is in communication with the unfiltered fluid inlet 310. In FIG. 13, it can be seen how the first filter assembly 102 has inlet opening 137, which is in sealed communication with the inlet 310. This allows air/fluid to be filtered, such as air from equipment (e.g., a 3D printer) to be conveyed via tubing or a hose to the inlet 310 and directly into the first filter assembly 102.

The first filter assembly 102 is positioned within the interior volume 308 of the housing 300. In the example shown, it is resting on a pair of runners 340, 341, generally against a bottom surface of the housing 300.

When assembled in the filter arrangement 300, the second filter assembly 104 is releasably sealed to the first filter assembly 102 with U-gaskets 314 by being positioned on top (stacked on top) of the first filter assembly 102.

A floating shelf 316 is movably secured to the housing 304. The floating shelf 316 includes an upper face 318, an opposite lower face 320, and a sump frame 322 extending from the lower face 320. The floating shelf 316 is movable between a first position (FIG. 22) and a second position (FIG. 24). In FIG. 22, the floating shelf 316 is in the first position, a position in which the second filter assembly 104 is releasably sealed to the sump frame 322. In FIG. 24, the floating shelf 316 is in the second position, a position in which the second filter assembly 104 is free of (not sealed to) the sump frame 322. In can be understood that the floating shelf 316 is adjustable to selectively seal the second filter assembly 104 to the sump frame 322. Gaskets, such as U-gaskets 330, 331 are positioned on an upper face 332 of the second filter assembly 104. The sump frame 322, when sealed to the second filter assembly 104, is against the U-gaskets 330, 331 (FIGS. 22 and 23). The sump frame 322, when free of (not sealed to) the second filter assembly 104, is axially spaced from the U-gaskets 330, 331 (FIG. 24).

Still in reference to FIG. 22, the filter arrangement 300 further comprises a fixed shelf 324 within the interior volume 308 of the housing 300 and secured to the housing 300. The floating shelf 316 is movably mounted to the fixed shelf 324. In the example embodiment shown, the fixed shelf 324 comprises a pair of fixed brackets 326, 327 secured within the interior volume 308 of the housing 300. The brackets 326, 327 are on opposite sides of the second filter assembly 104.

Mounted on the brackets 326, 327 of the fixed shelf 324 are springs 334, 335. The springs 334, 335 provide a spring force between the fixed shelf 324 (e.g., brackets 326, 327) and the floating shelf 316.

Also mounted on the brackets 326, 327 of the fixed shelf 324 are solenoids 336, 337. The solenoids provide a force against the floating shelf 316, when actuated. FIG. 24 shows the solenoids 336, 337 actuated. When actuated, the solenoids 336, 337 moves the floating shelf 316 away from the fixed shelf 324 (e.g., brackets 326, 327), which moves the sump from 322 and out of sealing engagement with the second filter assembly 104. The solenoids 336, 337 are actuated by an operator, when it is time to replace one or both of the filter assemblies 102, 104.

In reference again to FIG. 22, the arrangement 300 includes a pump shelf 342 secured within the housing interior volume 308. The pump shelf 342 has an upper surface 344, an opposite lower surface 346; and an opening 348. Pump 230 is positioned on the upper surface 344 of the pump shelf 342 over the opening 348. A spigot 350 extends from the opening 348 and from the lower surface 346 of the pump shelf 342 and away from the pump shelf 342. The floating shelf 316 is slidingly sealed to the spigot 350 with seal member 352. Therefore, when the second filter assembly 104 is secured to the sump frame 322, the second filter assembly 104 is also sealed to the spigot 350, by way of the sump frame 322. The pump 230 creates negative pressure and draws air flow through the stacked filter assembly 302.

As can be seen in FIG. 23, the filtered fluid outlet 312 is downstream of the pump shelf 342 and pump 230.

In operation, air to be filtered is drawn in by operation of the pump 230. The air enters the filter arrangement 300 through the inlet 310. It flows directly into the first filter assembly 102, where it is pre-filtered. The pre-filtered air flow then flows directly into the second filter assembly 104, without escaping into the housing interior 308 because of the seal at gaskets 314. The air is then filtered by the second filter assembly 104 and flows into an interior of the sump frame 322 and then through the spigot 350. From there, the air passes through the pump 230 and then exits the filter arrangement 300 through the outlet 312.

After filtering for some time, one or both of the filter assemblies 102, 104 will become occluded and need replacement. Typically, a sensor on the filters 102, 104 will give an indication to the filter operator that servicing is needed. At that time, the filter operator will activate a switch, which will actuate the solenoids 236, 237. The solenoids 236, 237 will move from the first position of FIGS. 22, 23 to the second position of FIG. 24. This will move the floating shelf 316 away from the fixed shelf 324 (e.g., brackets 326, 327), which moves the sump from 322 and out of sealing engagement with the second filter assembly 104. This then allows the filter operator to remove the stacked filter assembly 302 from the interior volume 308 of the housing 304. One or both of the filter assemblies 102, 104 are then replaced with new filter assemblies 102, 104 in the interior volume 308 of the housing 304. Next, the solenoids 236, 237 are disengaged to move the stacked filter assembly 302 into sealing engagement with the filtered fluid outlet 312. This is done by positioning the floating shelf 316 downward so that the second filter assembly 104 is releasably sealed with gaskets 330, 331 to the sump frame 322.

A method of filtering can be practiced by providing the housing 300 with surrounding wall 306 defining interior volume 308. Unfiltered fluid inlet 310 extends through the surrounding wall 306. Filtered fluid outlet 312 extends through the surrounding wall 306. The method includes putting stacked filter assembly 302 in communication with the unfiltered fluid inlet 310. The method includes disengaging the solenoid 336, 337 to move the stacked filter assembly 302 into sealing engagement with the filtered fluid outlet 312.

Having described the preferred aspects and implementations of the present disclosure, modifications and equivalents of the disclosed concepts may readily occur to one skilled in the art. However, it is intended that such modifications and equivalents be included within the scope of the claims which are appended hereto

1. A filter arrangement comprising:
(a) a first filter assembly;
(b) a second filter assembly; and
(c) a cam assembly to cause an airtight seal between the first filter assembly and second filter assembly.

2. The filter arrangement of claim 1 further comprising:
a housing with a surrounding wall defining an interior volume; an unfiltered fluid inlet through the surrounding wall; a filtered fluid outlet through the surrounding wall; and
wherein the first filter assembly, second filter assembly, and cam assembly are operably oriented within the interior volume of the housing.

3. The filter arrangement of claim 1 wherein the first filter assembly is positioned to rest on the cam assembly and receive unfiltered fluid from the unfiltered fluid inlet.

4. The filter arrangement of claim 3 further comprising:
(a) a fixed shelf within the interior volume of the housing and secured to the housing; and
(b) a floating shelf movably mounted to the fixed shelf; the floating shelf including an upper face, an opposite lower face, a first sump frame, and a second sump frame;
(i) the first sump frame extending from the lower face in a direction away from the floating shelf and sized and positioned to form a releasable seal with the first filter assembly; and
(ii) the second sump frame extending from the upper face in a direction away from the floating shelf and sized and positioned to form a releasable seal with the second filter assembly.

5. The filter arrangement of claim 4 wherein the second filter assembly is positioned on the fixed shelf and to provide filtered fluid to the filtered fluid outlet, and can be positioned on the first sump frame on the floating shelf, when the floating shelf is moved into such a position.

6. The filter arrangement of claim 5 wherein:
the cam assembly includes a pivotable handle controlling a cam lobe, wherein the cam lobe is positioned to push the first filter assembly into sealing engagement with the first sump frame and push the floating shelf toward the second filter assembly and the second sump frame into sealing engagement with the second filter assembly.

7. The filter arrangement of claim 6 further including:
(a) a pump shelf secured within the housing interior volume; the pump shelf having an upper surface, an opposite lower surface; and an opening;
(b) a pump positioned on the upper surface of the pump shelf over the opening; and
(c) a third sump frame extending from the lower surface of the pump shelf and away from the pump shelf; the third sump frame being sized and positioned to form a releasable seal with the second filter assembly.

8. The filter arrangement of claim 1, wherein the first filter assembly includes:
(a) an airtight outer box;
(b) a cage box positioned inside of the outer box; and
(c ) a removable and replaceable pocket bag filter member positioned in the cage box.

9. The filter arrangement of claim 1, wherein the second filter assembly includes a filter housing holding a removable and replaceable HEPA filter media section and carbon media section.

10. (canceled)

11. A method of filtering including:
(a) engaging a cam assembly to move a first filter assembly into sealing engagement with a first sump frame attached to a floating shelf;
(b) moving the floating shelf to result in sealing engagement between a second sump frame and a second filter assembly; and
(c) moving the second filter assembly into sealing engagement with a third sump frame.

12. The method of claim 11, wherein:
(a) the first filter assembly includes:
(i) an airtight outer box;
(ii) a cage box positioned inside of the outer box; and
(iii) a removable and replaceable pocket bag filter member positioned in the cage box; and
(b) the second filter assembly includes a filter housing holding a removable and replaceable HEPA filter media section and carbon media section.

13. A filter arrangement comprising:
(a) a housing with a surrounding wall defining an interior volume; an unfiltered fluid inlet through the surrounding wall; and a filtered fluid outlet through the surrounding wall;
(b) a first filter assembly in communication with the unfiltered fluid inlet;
(c) a second filter assembly releasably sealed to the first filter assembly;
(d) a floating shelf secured to the housing; the floating shelf including an upper face, an opposite lower face, and a sump frame extending from the lower face;
wherein the floating shelf is adjustable to selectively seal the second filter assembly to the sump frame.

14. The filter arrangement of claim 13, further comprising a fixed shelf within the interior volume of the housing and secured to the housing; and wherein the floating shelf is movably mounted to the fixed shelf.

15. The filter arrangement of claim 14, further comprising:
(a) a spring mounted on the fixed shelf and providing a spring force between the fixed shelf and the floating shelf; and
(b) a solenoid mounted on the fixed shelf to provide a force against the floating shelf, when actuated.

16. The filter arrangement of claim 15 further including:
(a) a pump shelf secured within the housing interior volume; the pump shelf having an upper surface, an opposite lower surface; and an opening;
(b) a pump positioned on the upper surface of the pump shelf over the opening; and
(c) a spigot extending from the opening and from the lower surface of the pump shelf and away from the pump shelf; the floating shelf being slidingly sealed to the spigot.

17. The filter arrangement of claim 16, wherein the filtered fluid outlet is downstream of the pump shelf and pump.

18. The filter arrangement of claim 13 wherein the first filter assembly includes:
(a) an airtight outer box;
(b) a cage box positioned inside of the outer box; and
(c ) a removable and replaceable pocket bag filter member positioned in the cage box.

19. The filter arrangement of claim 13 wherein the second filter assembly includes a filter housing holding a removable and replaceable HEPA filter media section and carbon media section.

20. (canceled)

21. A method of filtering comprising:
(a) providing a housing with a surrounding wall defining an interior volume; an unfiltered fluid inlet through the surrounding wall; and a filtered fluid outlet through the surrounding wall;
(b) putting a stacked filter assembly in communication with the unfiltered fluid inlet; and
(c) disengaging a solenoid to move the stacked filter assembly into sealing engagement with the filtered fluid outlet.

22. The method of claim 21, wherein the step of disengaging a solenoid includes moving a sump frame attached to a floating shelf to seal the stacked filter assembly to the sump frame.

23. The method of claim 22, wherein:
(a) a pump shelf is secured within the housing interior volume; the pump shelf having an upper surface, an opposite lower surface; and an opening;
(b) a is pump positioned on the upper surface of the pump shelf over the opening; and
(c) a spigot extends from the opening and from the lower surface of the pump shelf and away from the pump shelf, the floating shelf being slidingly sealed to the spigot.

24. The method of claim 21, wherein the stacked filter assembly includes:
(a) a first filter assembly in communication with the unfiltered fluid inlet; and
(b) a second filter assembly releasably sealed to the first filter assembly.
